(19) United States
(12) Patent Application Publication
(10) Pub. No.: US 2026/0101911 A1
(43) Pub. Date: Apr. 16, 2026

(54) Food Composition

(71) Applicant: Peter R Meroney, Ocala, FL (US)

(72) Inventor: Peter R Meroney, Ocala, FL (US)

(21) Appl. No.: 18/916,923

(22) Filed: Oct. 16, 2024

(51) Int. Cl. A23L 7/126; A23L 33/17

(52) U.S. Cl. CPC A23L 7/126; A23L 33/17

(57) ABSTRACT

The invention describes a new Cereal Grain Frozen Food Bar product, uses thereof, compositions thereof, and methods to prepare products formed from several varieties of processed and cooked cereal grains with other ingredients designed to turn ordinary milk based (Dairy, Plant, Nut, Oats, etc.) smoothies into convenient, protein and fiber rich nutritious full-bodied drinkable meals.

### BACKGROUND

### Field of the Invention

(1) The present invention is a Ready-To-Eat (RTE) fully cooked and preformed Cereal Grain Frozen Food Bar created specifically for any type of milk based (Dairy, Plant, Nut, Oats, etc.) smoothie. It is formulated to provide increased bulk using four types of grains with their associated nutrients and proteins (in addition to the milk and optional yogurt proteins), one type of powdered protein, four types of fiber (Soluble and Insoluble) from the grains and seeds (more if fruit is added), vitamins, minerals, and other nutrients all in one convenient ready to use frozen food bar. All of the grains are preprocessed and precooked, which saves both time and effort by turning an ordinary smoothie into a nutritional powerhouse with enhanced protein and fiber in one easy step from the freezer to the blender.

### Discussion of the Related Art

(2) Nutritionists have shown that grains provide a rich source of proteins, complex carbohydrates and fiber which facilitates slow digestion and stable blood glucose levels, all of which contribute to a healthy and well-balanced diet. The protein content in this initial formulation of oats (as a base and binder), wheat, rice and bran cereals is approximately 14.2%, 12%, 7.5%, and 5% w/w respectively. Note that the protein content of other optional grains (see Page 2-#3) will vary depending on the type of grain formulation used for a particular bar. This applies to the fiber content as well.

Using oatmeal as the primary base and natural binder is renowned for its rich nutritional composition and soluble fiber, which has been shown to reduce low-density lipoprotein (LDL) or “bad” cholesterol.

Additionally, it's also an excellent source of proteins, vitamins, minerals, and antioxidants. Some key nutrients found in oatmeal include: Soluble fiber, B vitamins (including B6 and folate), Magnesium, Potassium and Unsaturated fats.

(3) In addition to using the cooked oats (flakes or steel cut) as a base and natural binder, the three types of grain combinations added to the base/binder can be comprised of any processed and fully cooked grain such as Bran, Maize, Rice, Barley, Wheat, Sorghum, Millet, Rye, Triticale, Buckwheat, and/or exotics like Quinoa, Teff, Kanawa, Spelt, Einkorn, Emmer, Amaranth, Kamut and combinations thereof for different markets.

Furthermore, processed and cooked grains may be deformed from their discrete shapes into a multitude of forms including extruded cooked slurry mixtures for molds, flakes, shreds, flours and the like.

(4) The production technique involves processing various grain combinations of modern oats (flakes or steel cut) as the primary base/binder, pulverized bran plus any two fully processed and cooked pulverized grains from the list in item #3 above, seeds, coconut, sweetener (optional or from the list on Page 2-#6) and a protein powder suitable for human consumption into a fully cooked complete slurry that is cooled and subsequently extruded into specially designed molds (See mold design on Page 5-FIG. 1) and flash frozen.

(5) Creating the Base/Binder: Step 1—The initial preparation involves cooking the oats (flakes or steel cut) in a specific amount of water and for a specific amount of time until it reaches a certain consistency. This produces the base ingredient that also acts as a natural binder that contains enzymes, carbohydrates, soluble fiber, proteins and other nutrients. This method of using oatmeal as a primary base and natural binder eliminates the need for using artificial or chemical binders in the product.

(6) Combining the Remaining Ingredients: Step 2—Once the oats are fully cooked to the right consistency, the pulverized bran with the two additional fully cooked and processed pulverized grains (see Page 2-#3) and the other ingredients (see Page 2-#4) except the protein powder are added to the fully cooked hot oats and mixed well and allowed to cool for a specific period of time. Once cooled, the protein powder is added and thoroughly mixed into the slurry which is then ready for extrusion into the specially designed molds with raised break indentations that allow each frozen bar to be easily broken into four individual pieces. (See Figure #1 drawing on page 5)

(7) Due to the small amount of sweetener in the product, the manufacturer has the option of using any, none, or a combination of the following sweeteners: Brown, Raw, or any type of Granulated sugar, Molasses, Honey, Maple Syrup, Aspartame, Sucralose, Maltose, Saccharine, Fructose, Sucrose, Glucose, Xylitol, Maltitol and High Fructose Corn Syrup.

(8) Finally, once frozen, the shaped Ready-To-Eat product marketed under a specific brand name can be packaged and boxed up into individual bars of four to six bars each for distribution and sale. When kept frozen, the product retains a shelf life similar to other frozen foods.

1. A Cereal Grain Frozen Food Bar as recited in the Abstract (Page 1) comprising: A primary oatmeal base that also acts as a natural binder that is cooked to a certain consistency in all formulations using a proprietary amount of water to which three types of pulverized grains (out of nineteen varieties) are added along with other weighted ingredients to create a slurry for extrusion into specially designed molds for flash freezing.

2. The Cereal Grain Frozen Food Bar as recited in Background/Field of Invention (page 2-#3) further comprising: The option to use any three of nineteen varieties of grain combinations from the list using oatmeal as the primary base and natural binder for different markets making it the fourth grain in the formula along with the associated proteins, carbohydrates ahd fibers of the other individual grains.

3. (canceled)

4. (canceled)

5. (canceled)

6. (canceled)

7. (canceled)

8. (canceled)

9. (canceled)

10. The Cereal Grain Frozen Food Bar as recited in the Drawing (page 4-#1) further comprising: Detailed drawing of the rectangular mold with the raised end-to-end horizontal and side-to-side raised vertical indentions to create breakpoints in the food bar for the easy breaking apart of the frozen product into four individual pieces to allow for the use of the whole bar, part of it, or adding additional pieces to a smoothie.
